(19) United States
(12) Patent Application Publication
(10) Pub. No.: US 2026/0368241 A1
(43) Pub. Date: Nov. 19, 2026

(54) Machine-Learning System for Personalized Genre-Specific Media Recommendations Using Deep Metadata Relational Analysis

(71) Applicants: Jason Henderson, Littleton, CO (US); In Churl Yo, Sammamish, WA (US)

(72) Inventors: Jason Henderson, Littleton, CO (US); In Churl Yo, Sammamish, WA (US)

(21) Appl. No.: 19/207,441

(22) Filed: May 14, 2025

(51) Int. Cl. G06F 16/438; G06F 16/435

(52) U.S. Cl. CPC G06F 16/4387; G06F 16/437

(57) ABSTRACT

The invention provides a system and method for generating highly personalized media recommendations and playlists using machine learning and comprehensive metadata analysis. The system continuously aggregates metadata from licensed, user-generated, and machine-extracted sources, dynamically mapping relationships among metadata attributes. By integrating real-time user input and behavioral feedback, the system uncovers complex, non-obvious connections between content items, enabling the creation of adaptive, user-tailored playlists and recommendations that evolve in response to each user's unique preferences and interactions.

### CROSS-REFERENCE TO RELATED APPLICATIONS

N/A

### FIELD OF THE INVENTION

The present invention relates to the field of machine learning and artificial intelligence applied to media content recommendation systems. More specifically, it pertains to systems and methods for generating personalized, genre-specific media recommendations and playlists by dynamically analyzing and mapping hierarchical relationships among metadata from multiple sources-including user-generated, licensed, and machine-learning-extracted data-in order to deliver adaptive, user-tailored content discovery and selection experiences.

### APPROPRIATE CLASSIFICATIONS

G06N 3/04—Artificial neural networks; machine learning architectures
G06F 16/735—Content recommendation based on user preferences
G06F 17/30—Information retrieval using machine learning techniques
H04N 21/2343—Personalized content delivery in video processing
G06Q 30/06—Systems involving user modeling for personalized content delivery
H04N 21/2662—Editing of audio-visual content based on user preferences
G06T 11/60—Machine learning in image or video processing.

### BACKGROUND OF THE INVENTION

The rapid expansion of on-demand video and multimedia services has given users access to an overwhelming quantity and diversity of content. While traditional recommendation engines and curated playlists attempt to guide users toward relevant material, these systems are typically limited by static metadata, pre-defined taxonomies, or human-programmed rules, resulting in generic or repetitive suggestions that may not reflect the unique preferences of each user.

This invention addresses these limitations by leveraging artificial intelligence and machine learning to analyze and map relationships among all available metadata-including user-generated, licensed, and machine-extracted data. Unlike prior systems, the use of AI enables the discovery of complex, non-obvious connections between media items, allowing for the creation of highly personalized, adaptive recommendations and playlists that continuously evolve in response to individual user behavior and feedback.

### SUMMARY OF THE INVENTION

The present invention provides a system and method for generating highly personalized, genre-specific media recommendations and playlists through the use of artificial intelligence and machine learning. Unlike traditional recommendation engines that rely on static metadata or human-curated taxonomies, this invention continuously aggregates and analyzes metadata from a wide range of sources-including user-generated tags, licensed metadata such as closed captioning, and machine-extracted features-using advanced relational and graph-based analysis.

The system dynamically maps relationships among metadata attributes and integrates real-time user interactions, such as selections, exclusions, and search queries, to iteratively refine and focus its recommendations. This approach enables the discovery of complex and non-obvious connections between content items, allowing users to explore and hone their playlists in ways that reflect their unique and evolving interests.

As a result, the invention delivers recommendations that are not only tailored to explicit user preferences but also adapt to subtle behavioral patterns and contextual signals.

The invention includes the following components:
A real-time-updating metadata database that aggregates and continuously updates metadata from licensed, user-generated, and machine-learning sources.
A personalized user preference database that stores and analyzes metadata related to the individual preferences and interactions of each user.
An ordering system that prioritizes metadata attributes based on user preferences and contextual factors.
A database of lists of content used by the user, tracking historical and real-time selections and exclusions.
A user interface for displaying personalized playlists and enabling users to refine recommendations through direct input or voice commands.
An engine for generating playlists by analyzing and cross-referencing prioritized metadata relationships and user preferences.
A dynamic metadata relationship mapper that constructs and updates relational graphs between content items using deep metadata analysis.
An iterative feedback loop module that adjusts recommendation parameters in real time based on user interactions, ensuring continuous alignment with user interests.

Through this integrated and adaptive architecture, the invention achieves a level of personalization and discovery in media recommendations that far exceeds the capabilities of conventional systems.

### BRIEF DESCRIPTION OF THE DRAWINGS

A further understanding of the nature and advantages of various embodiments may be realized by reference to the attached figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label. It should be understood that television receiver [Number TBD], along with the other computerized systems and devices detailed herein, may include various computerized components including memories, processors, data buses, user interfaces, power supplies, etc. Such components have been omitted from the description and figures for simplicity.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the attached elements may be components of a larger system, wherein other rules may take precedence over or otherwise modify the application of the invention. Also, a number of steps may be undertaken before, during, or after the pictured elements are considered.

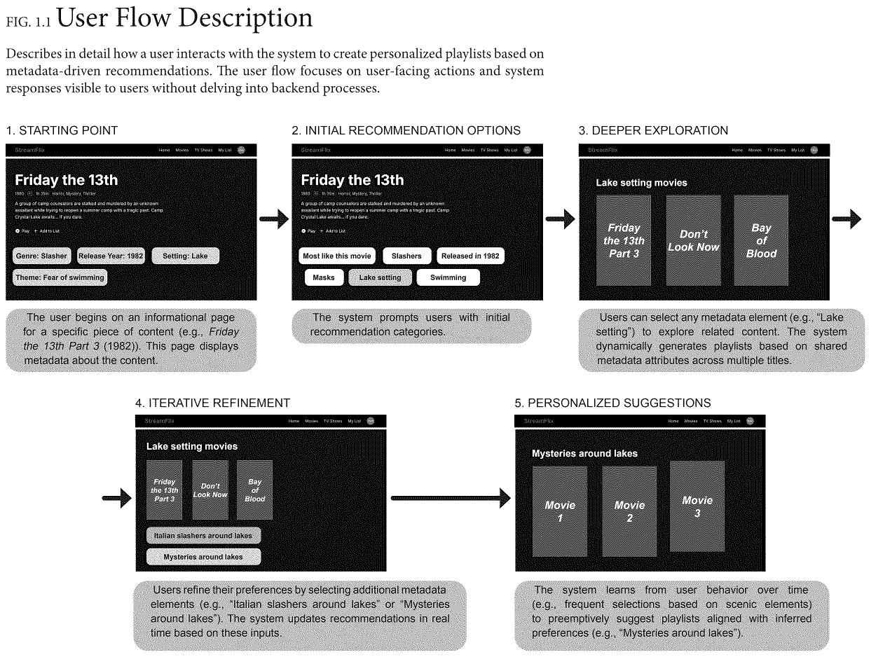

### FIG. 1.1 USER FLOW DESCRIPTION

FIG. 1.1 illustrates, step-by-step, the user-facing flow of the system as the user interacts with the recommendation engine to create personalized playlists:
Starting Point: The user begins at the home screen or informational page for a particular movie or show (e.g., Friday the 13th Part 3 (1982)).
Initial Recommendation Options: The system presents a variety of recommendation categories based on the selected content, such as “Most like this movie,” “Slashers,” as well as options based on specific metadata elements (e.g., “1982,” “Released in 3D,” “Masks,” “Lake setting,” “Swimming”).
Deeper Exploration: The user can select any metadata element to explore further. The system draws upon user-generated metadata, licensed metadata (such as closed captioning), and machine-learning-extracted metadata to surface additional elements, such as “Dialogue about lakes expressing fear,” “Dialogue about swimming—negative,” or “Dialogue about swimming—positive.”
Playlist Creation: If multiple content items share a selected metadata element, the system creates a playlist based on that attribute (e.g., “Horror Movies with dialogue about swimming-negative” might include Friday the 13th Part 3 (1982), Don't Look Now (1973), and Bay of Blood (1971)).
Iterative Refinement: The user can continue to explore deeper into each title, uncovering more granular elements (e.g., “Italian slashers around lakes,” “Italian mysteries,” or “Mysteries around lakes-1970s”) and generating new playlists accordingly.
Personalized Suggestions: The system learns from the user's exploration and prior choices, offering personalized recommended playlists (such as “Mysteries around lakes”) at the start of subsequent sessions. These recommendations are continuously updated based on the user's selections and searches.

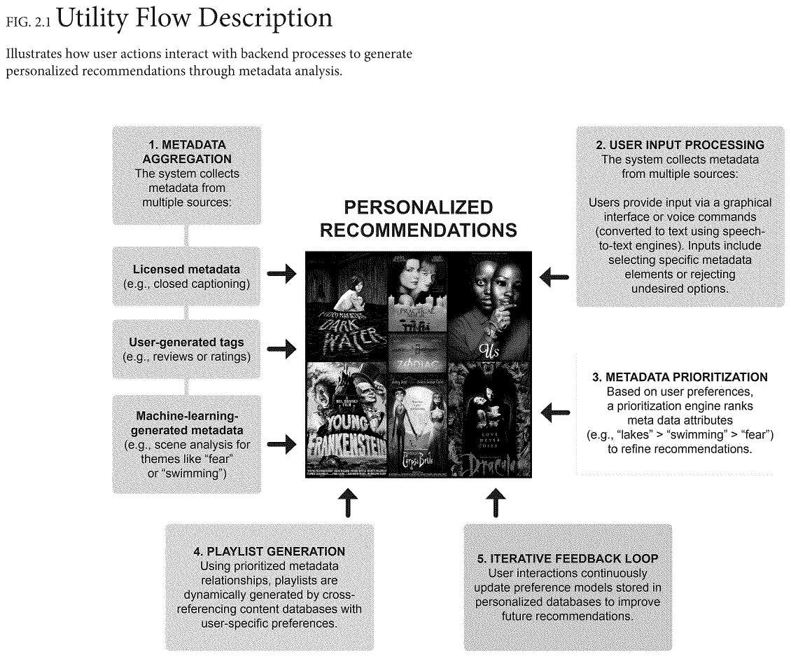

### FIG. 2.1 Utility Flow Description

FIG. 2.1 illustrates how user actions interact with backend processes to generate personalized recommendations and playlists through comprehensive metadata analysis and machine learning. The process is as follows:
Metadata Aggregation: The system begins by collecting metadata from multiple sources to ensure a comprehensive understanding of the available content. This includes:
Licensed metadata: Such as closed captioning, official genre tags, production credits, and other descriptors provided by content owners or distributors.
User-generated tags: Including reviews, ratings, custom tags, and other forms of user input that describe or categorize content.
Machine-learning-generated metadata: Features extracted automatically by algorithms, such as scene-level thematic analysis (e.g., identifying themes like “fear”or “swimming”) , audio-visual attributes, and inferred relationships between content elements.
User Input Processing: Users interact with the system through a graphical user interface or via voice commands, which are converted to text using speech-to-text engines. User inputs may include:
Selecting specific metadata elements (e.g., choosing to see only movies set around lakes, or with a certain theme).
Rejecting or excluding undesired options (e.g., excluding movies with a particular actor or genre).
Providing real-time requests or refining preferences during their session.
Metadata Prioritization: The system employs a prioritization engine that ranks metadata attributes based on the user's expressed preferences and historical behavior. For example:
If a user frequently selects content with the “lake” setting, the system will prioritize metadata related to lakes over other attributes like “swimming” or “fear.”
The prioritization engine may also consider contextual factors, such as the time of day, device type, or collaborative trends from similar users.
Playlist Generation: Using the prioritized metadata relationships, the system dynamically generates playlists by cross-referencing the content database with the user's specific preferences. This involves:
Constructing a list of content items that best match the ranked metadata attributes.
Ensuring diversity and relevance in the playlist by leveraging both explicit user selections and implicit behavioral signals.
Presenting the generated playlist to the user for immediate exploration or playback.
Iterative Feedback Loop: As the user interacts with the playlists-by making selections, exclusions, or providing further feedback-the system continuously updates the user's preference model and the underlying metadata relationships. This feedback loop ensures that:
Future recommendations become increasingly personalized and accurate.
The system adapts in real time to changes in user interests or behavior, offering a dynamic and evolving recommendation experience.

Through this stepwise process, the invention enables the creation of highly personalized, adaptive playlists and recommendations, leveraging the full spectrum of available metadata and user interactions for optimal content discovery and engagement.

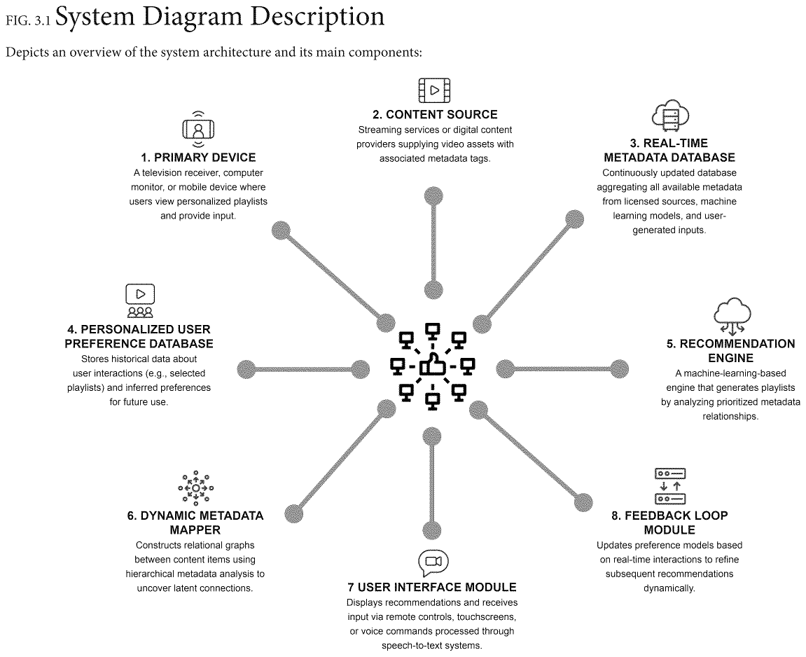

### FIG. 3.1 System Diagram

FIG. 3.1 depicts an overview of the system architecture and its principal components, illustrating how metadata aggregation, user preferences, and machine learning interact to generate personalized recommendations. The components are as follows:
Primary Device: A television receiver, computer monitor, or mobile device where users view personalized playlists and provide input (e.g., voice commands, touchscreen selections).
Content Source: Streaming services or digital content providers supplying video assets with associated metadata tags (e.g., genre, cast, scene descriptions).
Real-Time Metadata Database: Aggregates and continuously updates metadata from licensed sources (e.g., closed captioning), user-generated inputs (e.g., reviews), and machine-learning-extracted features (e.g., thematic scene analysis).
Personalized User Preference Database: Stores historical interaction data (e.g., selected playlists, dwell times) and inferred preferences (e.g., genre affinity, thematic interests) to refine future recommendations.
Recommendation Engine: A machine-learning-based system that generates playlists by analyzing prioritized metadata relationships and cross-referencing them with user preferences.
Dynamic Metadata Mapper: Constructs relational graphs between content items using hierarchical metadata analysis (e.g., linking “lake settings” to “fear of swimming” via dialogue analysis).
User Interface Module: Displays recommendations and receives input via remote controls, touchscreens, or voice commands processed through speech-to-text systems.
Feedback Loop Module: Updates preference models in real time based on user interactions (e.g., playlist edits, exclusions), ensuring continuous refinement of recommendations.

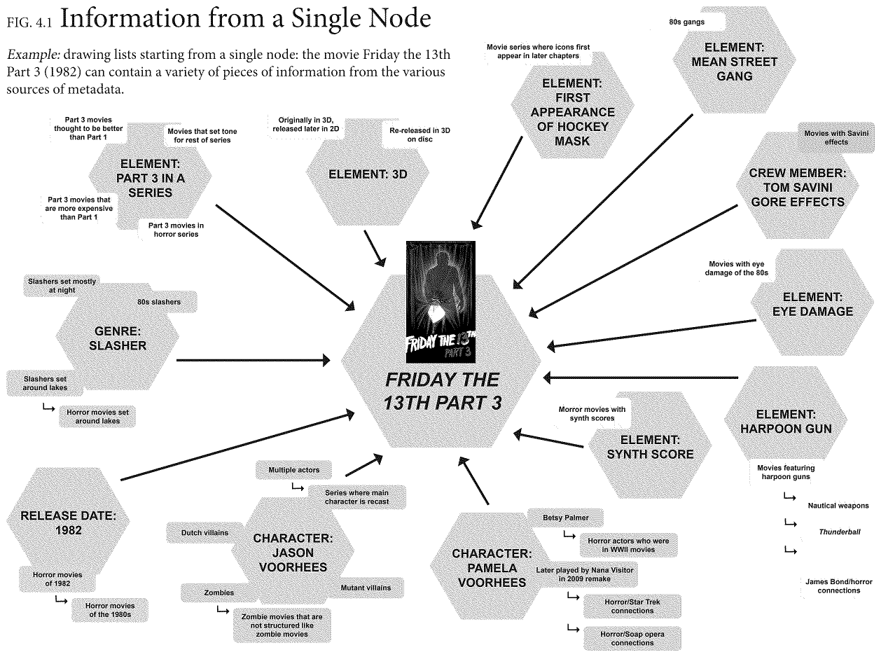

### FIG. 4.1: Information from a Single Node

FIG. 4.1 illustrates how the system draws upon and organizes a wide variety of metadata starting from a single node within the metadata relationship graph-in this example, the movie Friday the 13th Part 3 (1982). The system aggregates and connects metadata from multiple sources, including licensed data, user-generated tags, and machine-learning-extracted features, to enable the creation of highly nuanced and contextually relevant playlists or recommendations.

Starting from a single content item, the system identifies and displays a diverse set of metadata elements associated with that item, such as:

### Series and Franchise Relationships:

“Part 3 in a series”
“Part 3 movies in horror series”
“Movies that set the tone for the rest of the series”
“Part 3 movies thought to be better than Part 1”
“Part 3 movies that are more expensive than Part 1”

### Genre and Subgenre:

“Genre: Slasher”
“80s slashers”
“Slashers set around lakes”
“Horror movies set around lakes”
“Slashers set mostly at night”

### Release Information:

“Release date: 1982”
“Horror movies of 1982”
“Horror movies of the 1980s ”

### Technical and Thematic Elements:

“Element: 3D”
“Originally in 3D, released later in 2D”
“Re-released in 3D on disc”
“Element: First appearance of hockey mask”
“Movie series where icons first appear in later chapters”
“Element: Mean street gang”
“80s gangs”
“Crew member: Tom Savini gore effects”
“Movies with Savini effects”
“Element: Eye damage”
“Movies with eye damage of the 80s ”
“Element: Harpoon gun”
“Movies featuring harpoon guns”
“Nautical weapons”
“Thunderball”
“James Bond/horror connections”
“Element: Synth score”
“Horror movies with synth scores”

### Character and Actor Relationships:

“Character: Jason Voorhees”
“Dutch villains”
“Mutant villains”
“Zombies”
“Zombie movies that are not structured like zombie movies”
“Multiple actors”
“Series where main character is recast”
“Character: Pamela Voorhees”
“Betsy Palmer”
“Horror actors who were in WWII movies”
“Later played by Nana Visitor in 2009 remake”
“Horror/Star Trek connections”
“Horror/soap opera connections”

This example demonstrates how, starting from a single node, the system is able to surface and connect a rich network of metadata attributes. These connections enable the system to generate highly specific playlists (such as “80s slashers set around lakes” or “movies with synth scores and harpoon guns”) or to recommend related content based on any combination of these attributes. The process highlights the system's ability to leverage deep, multi-source metadata for flexible and adaptive content discovery and recommendation.

1. A system for generating personalized media recommendations and playlists using machine learning and metadata analysis, comprising:
a real-time-updating metadata database aggregating metadata from licensed sources, user-generated inputs, and machine-learning-extracted features;
a personalized user preference database storing historical and real-time interaction data; and
a recommendation engine configured to:
analyze hierarchical relationships within the metadata using deep relational analysis, wherein the recommendation engine employs a graph neural network to identify latent connections between content items based on shared metadata;
generate playlists by cross-referencing metadata relationships with user preferences, wherein the generated playlists include only content items whose relevance scores exceed a predefined confidence threshold; and
dynamically update recommendations based on iterative user feedback.

2. The system of claim 1, wherein the metadata database aggregates data from streaming platforms, editorial sources, and user tagging activity.

3. The system of claim 1, wherein the recommendation engine employs a graph neural network to identify latent connections between content items based on shared metadata.

4. The system of claim 1, wherein the generated playlists include only content items whose relevance scores exceed a predefined confidence threshold.

5. The system of claim 1, wherein the personalized user preference database updates in real time based on user interactions including selections, skips, and dwell time.

6. The system of claim 1, wherein the metadata database organizes genre information in a hierarchical structure comprising genres and subgenres.

7. The system of claim 1, wherein the recommendation engine accounts for contextual factors including time of day and device type when generating recommendations.

8. The system of claim 1, wherein user input is received via a graphical interface or voice command and processed to select or exclude specific metadata elements.

9. The system of claim 1, further comprising a feedback loop module configured to refine future recommendations based on user responses to generated playlists.

10. The system of claim 1, wherein the recommendation engine generates playlists by prioritizing metadata attributes based on user interaction patterns and contextual factors.

11. A method for generating personalized media recommendations and playlists, comprising:
aggregating metadata from licensed sources, user-generated tags, and machine-learning-extracted features;
storing and updating user preferences and interaction data in a personalized database;
prioritizing metadata attributes based on user preferences and behavior;
generating playlists by cross-referencing prioritized metadata with the content database, wherein generating playlists comprises applying a graph neural network to identify latent connections between content items based on shared metadata, and wherein the generated playlists include only content items whose relevance scores exceed a predefined confidence threshold; and
updating recommendations and preference models in real time based on user feedback.

12. The method of claim 11, wherein user input is received via a graphical interface or voice command and processed to select or exclude specific metadata elements.

13. The method of claim 11, wherein the system employs machine learning models to uncover non-obvious relationships between content items.

14. The method of claim 11, further comprising displaying generated playlists to the user and enabling iterative refinement through additional user input.

15. The method of claim 11, wherein the system adapts recommendations in response to contextual signals including time of day or device type.

16. The method of claim 11, wherein the system generates playlists with confidence scores exceeding a predefined threshold.

17. The method of claim 11, wherein the personalized database tracks user behavior including dwell time, skip rates, and real-time selections or exclusions.

18. The method of claim 11, further comprising updating metadata relationships in real time in response to user interactions.

19. The method of claim 11, wherein the method further comprises refining future recommendations based on user responses to generated playlists.

20. A non-transitory computer-readable medium storing instructions that, when executed by a processor, cause the processor to perform the steps of a method for generating personalized media recommendations and playlists, the method comprising:
aggregating metadata from licensed sources, user-generated tags, and machine-learning-extracted features;
storing and updating user preferences and interaction data in a personalized database;
prioritizing metadata attributes based on user preferences and behavior;
generating playlists by cross-referencing prioritized metadata with the content database, wherein generating playlists comprises applying a graph neural network to identify latent connections between content items based on shared metadata, and wherein the generated playlists include only content items whose relevance scores exceed a predefined confidence threshold; and
updating recommendations and preference models in real time based on user feedback.
